(19) United States
(12) Patent Application Publication
(10) Pub. No.: US 2021/0035326 A1
(43) Pub. Date: Feb. 4, 2021

(54) HUMAN POSE ESTIMATION SYSTEM

(71) Applicant: TOKYO INSTITUTE OF TECHNOLOGY, Tokyo (JP)

(72) Inventors: Hideki KOIKE, Tokyo (JP); Dong-Hyun HWANG, Tokyo (JP)

(73) Assignee: TOKYO INSTITUTE OF TECHNOLOGY, Tokyo (JP)

(21) Appl. No.: 16/944,332

(22) Filed: Jul. 31, 2020

(30) Foreign Application Priority Data
Aug. 2, 2019 (JP) 2019-142943
Jul. 21, 2020 (JP) 2020-124704
Jul. 31, 2020 (JP) 2020-130922

(51) Int. Cl. G06T 7/73; G06T 7/246; H04N 5/232

(52) U.S. Cl. CPC G06T 7/73; G06T 7/246; H04N 5/23238; G06T 2207/30196; G06T 2207/20076; G06T 2207/30244; G06T 2207/20081

(57) ABSTRACT

A motion measurement system including a wide-angle camera configured to capture in the periphery of an image at least a part of a body of a subject when the wide-angle camera is mounted on the body, a feature point extractor configured to extract feature points from the image, and a 3D pose estimator configured to estimate 3D pose data of the subject by using the feature points.

### CROSS REFERENCE TO RELATED APPLICATIONS

The present application claims priority from Japanese Patent Application No. 2019-142943 filed on Aug. 2, 2019, Japanese Patent Application No. 2020-124704 filed on Jul. 21, 2020 and Japanese Patent Application No. 2020-130922 filed on Jul. 31, 2020, the contents of which are hereby incorporated by reference in this application.

### BACKGROUND OF THE INVENTION

### Field of the Invention

The disclosure relates to a motion measurement system.

### Description of the Related Art

Motion capture technology that is capable of automatically extracting and displaying singular points and feature information of a subject's motion has been disclosed as prior art. Patent Literature 1 (Japanese Unexamined Patent Application Publication No. 2017-53739) discloses one example of this technology.

Motion capture techniques that use an optical system for measuring human motion are well known conventional techniques of motion capture technology. A measurement method based on such an optical system involves, for example, the use of markers, multiple cameras, and an image processing device. These markers are attached to a number of points on the body of a subject. Multiple cameras are placed at different angles so that the movement of markers are measured based on the principle of triangulation and images are taken in time series. The image processing device then acquires time series information on the 3D (three-dimensional) positions of markers from the image information of the multiple cameras.

To give an example, by positioning multiple cameras so that they face a specific indoor area and follow the markers, a subject's movement within this area is measured. The problem, however, with this measurement method is that the movement of the subject cannot be detected unless the subject is within a specific area such as indoor space where the subject can be captured with the cameras. These techniques are therefore unsuitable for taking measurements across a wide area such as outdoor space. In other words, the scope is limited with regards to where measurements can be taken.

Motion capture techniques based on wireless communication are also known where various sensors such as an accelerometer or a gyroscope sensor are attached to a subject's body.

In the case of wireless-communication-based motion capture techniques, a subject wears a full body suit on which markers or various sensors such as a gyroscope sensor are attached at selected positions.

However, the putting on and off of the full body suit and various sensors are a laborious process and adds to the burden of the subject.

The object of the disclosure, therefore, is to provide a motion measurement system that (i) reduces the burden of a subject that accompany the putting on and off of necessary equipment and (ii) is capable of capturing the movement of the subject without the image taking space being restricted so that, for example, measurement can be taken in outdoor space.

### SUMMARY

The motion measurement system according to the disclosure includes (i) a wide-angle camera configured to capture an image including at least a part of a body of a subject by wearing the wide-angle camera on the body of the subject, (ii) a feature point extractor configured to extract a feature point from the image, and (iii) a 3D pose estimator configured to estimate a 3D pose of the subject by using the feature point.

According to the disclosure, an image that captures at least a part of the subject's body is taken with a wide-angle camera. The feature point extractor extracts a feature point of the subject from the image. The 3D pose estimator estimates a 3D pose of the subject from the feature point.

In this way, a motion measurement system is provided that reduces the burden that accompany the putting on and off of necessary equipment by a subject and is capable of capturing the movement of the subject without the image taking space being restricted so that, for example, measurement can be taken in outdoor space.

### BRIEF DESCRIPTION OF THE DRAWINGS

FIG. 1 is a perspective diagram illustrating a wide-angle camera that is worn on a subject's chest and is used for taking an image for a motion measurement system according to a first embodiment.

FIG. 2 illustrates an example of an image taken by a wide-angle camera according to a first embodiment, in which parts of a subject's body are shown distorted around the periphery.

FIG. 3 is a schematic diagram showing the image pickup range of a motion measurement system according to a first embodiment when a wide-angle camera is worn at the front of a subject's chest.

FIG. 4 is a schematic diagram showing a processing sequence performed by a motion measurement system according to a first embodiment, with illustrations of Stage A1 to Stage G1 shown.

FIG. 5A and FIG. 5B are block diagrams explaining the configuration of a motion measurement system according to a first embodiment with a focus on a feature point extractor.

FIG. 6 is a functional block diagram explaining the configuration of a motion measurement system according to a first embodiment with a focus on a 3D pose estimator.

FIG. 7 is a flowchart showing the processing steps of a motion measurement system according to a first embodiment.

FIG. 8 is a conceptual schematic diagram of a motion measurement system according to an embodiment in which a 3D pose estimator is combined with a camera pose estimator, shown by A, or with a head pose estimator, shown by B.

FIG. 9 is a block diagram showing the configuration of a system body of a motion measurement system according to a second embodiment that performs correction of a pose of a subject's body from a pose of a camera.

FIG. 10 is a block diagram showing the configuration of a system body of a motion measurement system according to a third embodiment that estimates a line of sight through estimating a head pose.

FIG. 11 is a schematic diagram showing a processing sequence to project a view in a line of sight of a subject from a head pose by a motion measurement system according to a third embodiment.

FIGS. 12A-12D concerns a motion measurement system according to a third embodiment: FIG. 12A shows an example of an image captured with a wide-angle lens; FIG. 12B is a plane drawing in a direction of a line of sight that has been converted from FIG. 12A; FIG. 12C shows another example of an image captured with a wide-angle camera lens; FIG. 12D is a plane drawing in a direction of a line of sight that has been converted from FIG. 12C.

FIG. 13 is a schematic drawing concerning a motion measurement system according to a third embodiment that shows that an image B1 captured by a wide-angle camera and an image H1 in an actual line of sight are different.

FIG. 14 is a schematic drawing concerning a motion measurement system according to a third embodiment that shows how an image B2 in which an image captured by a wide-angle camera is matched with and an image in an actual line of sight is generated.

### DETAILED DESCRIPTION OF THE PREFERRED EMBODIMENT

### First Embodiment

### Measurement System 10

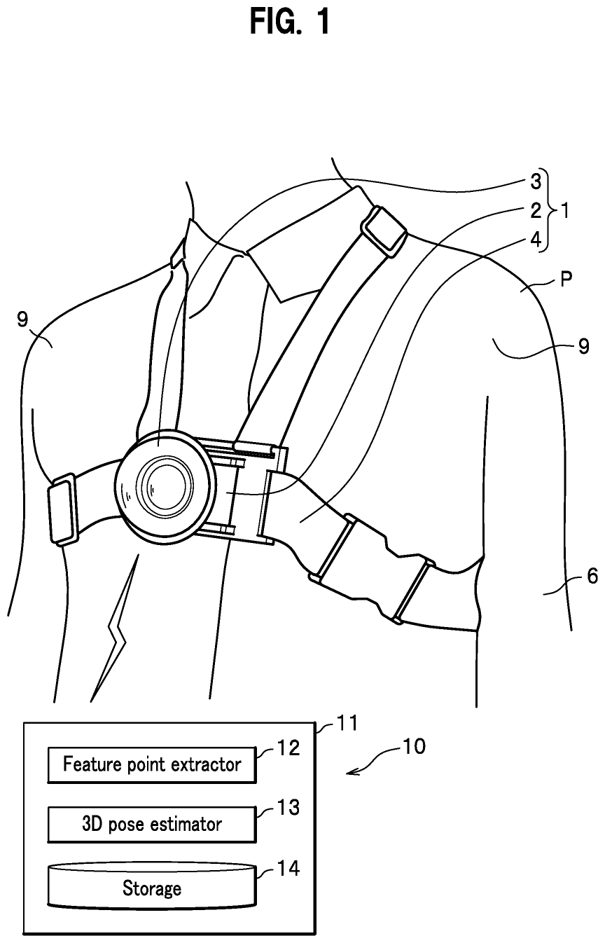

As shown in FIG. 1, a measurement system 10 that is connected to a wide-angle camera 1 via wireless communication includes the following parts within a box-shaped system body 11: (i) a feature point extractor 12 that extracts feature points; (ii) a 3D pose estimator 13 that estimates a 3D pose (a three-dimensional pose) of a subject P using feature points, and (iii) a storage 14 that stores individual data. The feature point extractor 12 mainly includes a CPU, and the storage 14 is configured mainly from a storage medium.

Furthermore, the measurement system 10 is configured to enable transmission of data with the wide-angle camera 1 via a communication part (not shown).

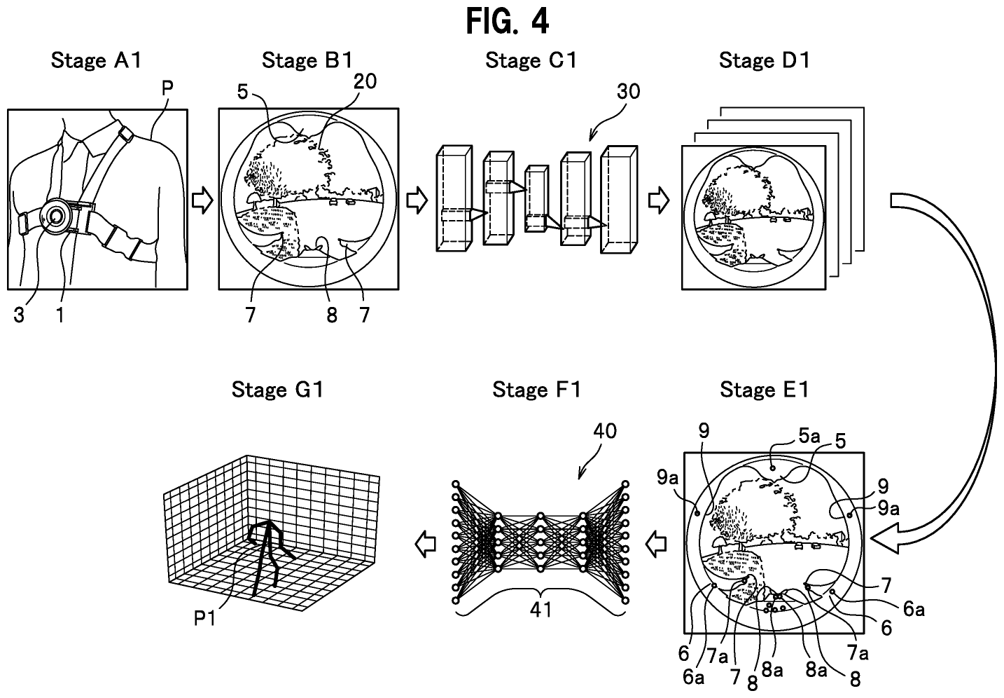

Hence, image data of an image taken by the wide-angle camera 1 that is mounted on a subject P's chest (as shown by the illustration provided in FIG. 4 for Stage A1) is sent by the wide-angle camera 1 via a communication part and is received by the measurement system 10. As shown by the illustration provided in FIG. 4 for Stage B1, the image data contains the subject P's body parts including a chin 5, hands 7, and legs 8 that have been captured and that appear around the periphery of the image, together with the front view 20.

### Learning of Training Data (Samples)

In order to perform learning of training data (samples), there is a method of collecting data for machine learning (deep learning) where a sample creator wears the wide-angle camera 1 on the sample creator's own chest, in the same way as a subject P would.

However, having a sample creator wear a camera for collecting enormous amounts of data (for example, 150,000 frames) to improve accuracy is not realistic, given the burden of the sample creator.

For the learning of samples according to the embodiment, a sample creator is replaced by a subject, and a virtual subject configured from data is used to collect a lot of data in a short space of time.

Parameters such as weight, height, clothes, and weather and time of day that are used for a background image are used for the virtual subject. Data of the virtual subject is collected by changing these parameters and parameter combinations. The collected data is stored in the storage 14 of FIG. 1.

With accumulated data of approximately 150,000 images, for example, learning that sufficiently complements 3D data is possible. Furthermore, accuracy may be raised further by using, for example, an efficient combination of parameters.

### Feature Point Extractor 12

The feature point extractor 12 of the measurement system 10 (FIG. 1) includes an encoder 30 (an autoencoder), as shown by the illustration provided in FIG. 4 for Stage C1.

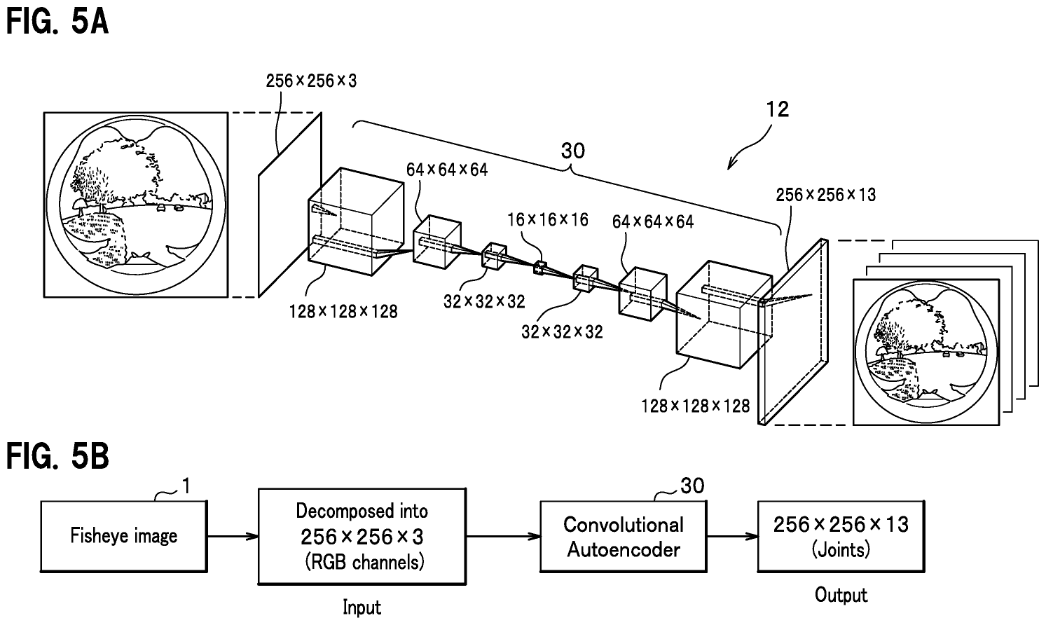

A configuration of the encoder 30 is described using FIG. 5. The encoder 30 of the embodiment uses training data acquired through machine learning from 2D images in order for a neural network to extract feature points.

In FIG. 5A, data sizes are represented by the size of each box. Data of a 2D image taken by the fisheye lens 3 is decomposed into 256×256×3 (height×width×[RGB channels]) parts and input to the encoder 30.

The encoder 30 encodes 2D (two-dimensional) image data to make it suitable for the next processing stage. The encoder 30 processes data of a taken 2D image by applying a heat map module and decomposes the data appropriately as shown by the illustration provided in FIG. 4 for Stage D1. The processing of the data of the taken 2D image includes normalization (standardization or simplification [or abstraction]) and exclusion (truncation). Here, data is decomposed into thirteen 2D images (probability distribution maps).

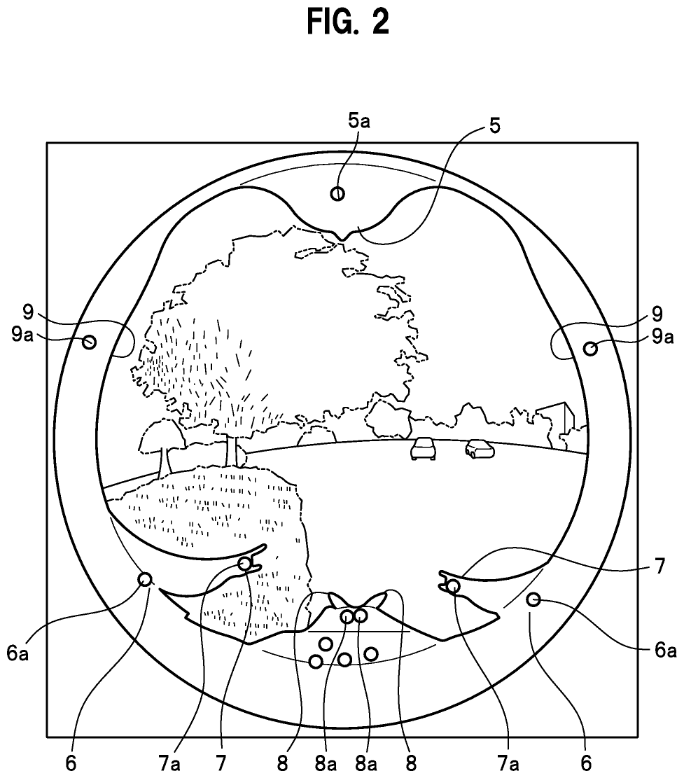

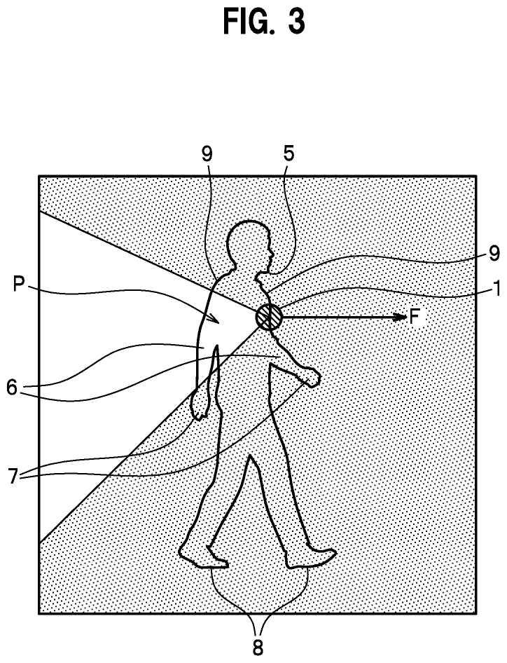

As shown by the illustration provided in FIG. 4 for Stage E1, parts corresponding to a chin 5, elbows 6, hands 7, legs 8, and shoulders 9 where the probability density is highest become feature points 5a-9a that are a set of 2D coordinates (see FIG. 2).

### 3D Pose Estimator 13

Next, as shown by the illustration provided in FIG. 4 for Stage F1, a set of 2D coordinates including feature points 5a-9a is converted to 1D vectors and sent to a decoder 40 of the 3D pose estimator 13.

The decoder 40 of the embodiment is configured from a neural network (fully connected layers 41) and converts information of multiple 2D data sets that are encoded to 3D image data.

In the decoder 40 of the embodiment, a 3D pose is estimated using training data acquired in advance through machine learning.

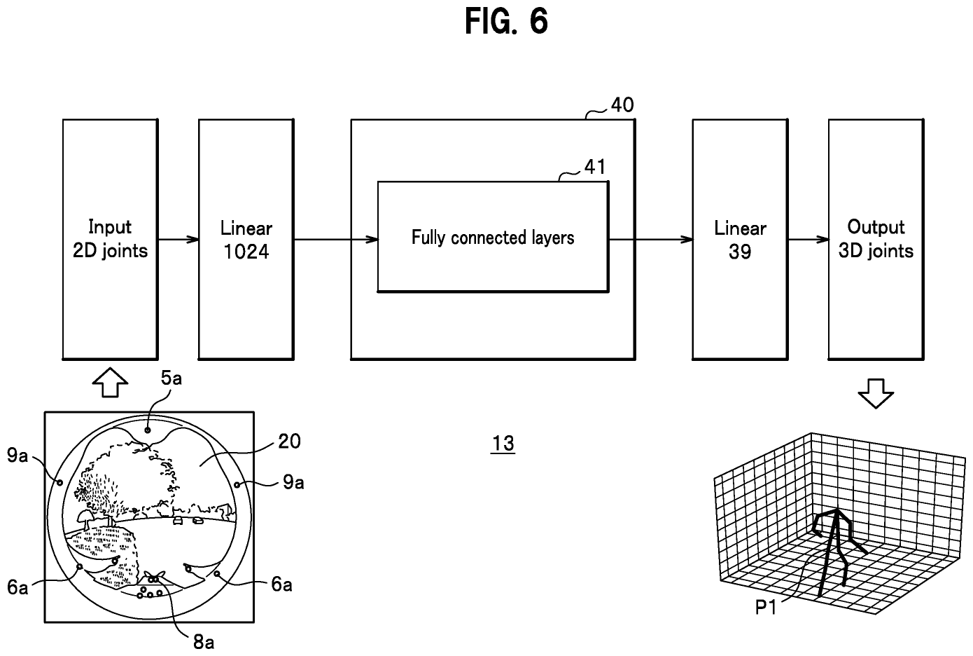

As shown in FIG. 6, the decoder 40 inputs numerical values of a set of 2D coordinates that have undergone 1D vectorization to the fully connected layers 41 (acting here as a BodyPoseNet; hereinafter also BPN) and outputs a set of 3D coordinates as 1D vectors. In this way, 3D coordinates of joints are estimated based on a 2D positional relationship of individual joints.

In this way, the 3D pose estimator 13 generates pose data P1 that shows the 3D pose of the subject P (as shown in the illustration provided in FIG. 4 for Stage G1) from the decomposed, thirteen 2D images using the decoder 40.

In this way, a 2D image (see the illustration provided in FIG. 4 for Stage B1) taken by the wide-angle camera 1 (see the illustration provided in FIG. 4 for Stage A1) becomes a 3D image (see the illustration provided in FIG. 4 for Stage G1) showing a 3D pose of the subject P through the 3D pose estimator 13 that uses pre-stored training data.

As a result, there is no need for a subject P to put on and off a full body suit or various sensors, thus reducing the labor involved. Furthermore, a motion measurement system is provided that is capable of capturing the movement of a subject without being restricted with regards to the area where an image is taken, enabling, for example, the movement of a subject to be captured in outdoor space.

### Extraction of Feature Points

Extraction of feature points will now be described.

The encoder 30 of the feature point extractor 12 decomposes a 2D fisheye image that has been taken into multiple 2D images according to a heatmap module as shown by the illustration provided in FIG. 4 for Stage D1.

As shown by the illustration provided in FIG. 4 for Stage E1, parts that correspond to a chin 5, elbows 6, hands 7, legs 8, and shoulders 9 are extracted as features points 5a-9a and attached to a 2D image (see FIG. 2). Because of training data that is provided in advance, the position accuracy of the feature points 5a-9a can be increased during this process.

Note that instead of using training data, a constraint condition that is given in advance may be used. For example, a same combination of constraints as a human skeletal structure may be used.

The feature point extractor 12 of the embodiment first extracts a chin shown as a reverse mound shape in the top part of a 2D image around the periphery and allocates a feature point 5a.

The feature point 5a is derived based on probability. For example, consider a case where a body of the subject P has constraints such as there being an elbow and a hand on either side of a chin and there being a left and right leg below a left and right hand respectively. In this case, the feature point extractor 12 decides that the part that dips that is located at the top of an image has the highest probability of being a chin.

Next, given the constraints, the feature point extractor 12 decides that the part existing on each of the two sides of the chin have the highest probability of being an elbow and a hand.

Next, the feature point extractor 12 decides that the probability of the upper part of an arm above an elbow having a shoulder is most high.

Also, the probability of there being legs on the other side of the chin and below the hands is most high. Based on these probability-based decisions made iteratively, feature points 5a-9a are allocated that each correspond to individual joints and body parts such as a chin 5, an elbow 6, a hand 8, a leg 8, and a shoulder 9.

However, there are cases where an arm disappears from the periphery of an image, depending, for example, on the way the arm is swung back and forth.

Even in such cases where an arm is not shown in a 2D image captured by the wide-angle camera 1, the feature point extractor 12 of the embodiment can complement the arm by using deep learning (machine learning).

In other words, feature points are extracted from a 2D image based on probability. When performing this extraction, feature points are not extracted all at once from a single image. A location of the part corresponding to a face is determined probabilistically.

For example, an inference is made on a location that is likely to have the highest probability of being a chin 5 is (see FIG. 2). During this process, not only is the position of chin 5 inferred from information such as color, contrast, and angle as in conventional image processing, but training data that has been acquired as a result of deep learning is used as well. Because the inference on the chin 5's position is derived from multiple data sets that have been learned, the accuracy with which the position can be located is better compared to simple image processing.

Next, an inference that there are shoulders 9, 9 on the left and right sides of the chin 5 is made.

In general, 3D data cannot be derived from 2D data. In particular, with a conventional program where body parts are recognized based on a condition that the body parts are connected by joints, 3D data is difficult to acquire directly from an image when that image is obtained with a fisheye lens and body parts such as a chin 5, elbows 6, hands 7, legs 8, and shoulders 9 appear individually around the periphery as in FIG. 2.

With the embodiment, by using data accumulated through learning from 2D data and using the heat map module's probability, it is possible to infer 3D data from 2D data.

With images taken with a fisheye lens, an elbow 6, for example, can sometimes disappear from the images when the elbow 6 is moved to the back of a body.

Even in such cases, through repeated learning, 3D data can be complemented and generated by inferring that the elbow 6 has moved to the back of a body from information such as information on all the feature points or information on a series of moves. If a feature point has been lost, then the feature point that should exist is inferred from the rest of the feature points.

Furthermore, through learning based on past image data, the accuracy with which 3D data can be reconstructed may be raised.

### Estimation of 3D Pose

Feature points derived in this way are stored in the storage 14 shown in FIG. 1.

As shown in FIG. 6, the 3D pose estimator 13 estimates a 3D pose. The 3D pose is estimated by a neural network (fully connected layers 41) of the decoder 40 as shown by the illustration of Stage F1 provided in FIG. 4. The estimated 3D pose is inferred from probability that use multiple training data sets acquired in advance from machine learning.

During this process, the 3D pose estimator 13 of the motion measurement system according to the embodiment may connect the feature points to configure a skeletal structure within data. Data of a skeletal structure that are used as physical constraints for configuring a skeletal structure within data may, for example, be stored in advance in the storage 14. However, providing such prior data is not necessary because it is possible for the 3D pose estimator 13 of the embodiment to configure a skeletal structure within data by connecting feature points.

Also, by collecting training data of the individual feature points 5a-9a that form a skeletal structure together with the learning of samples, training data that is necessary for the 3D pose estimator 13 to configure a skeletal structure may be collected efficiently.

In this way, by connecting the feature points 5a-9a so that the combinations of connections are the same as those of a human skeletal structure, pose data P1 of a skeletal structure part describing a 3D pose is configured, as shown by the illustration of Stage G1 in FIG. 4.

### Process of Motion Measurement System

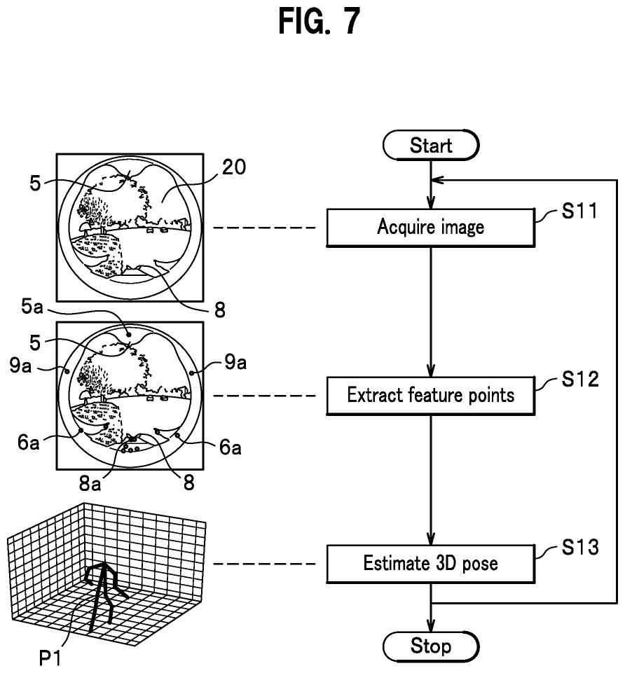

FIG. 7 shows a flowchart of processing steps of a measurement system 10 of the embodiment. When the process of the measurement system 10 begins, in step S11, the measurement system 10 acquires image data sent from the wide-angle camera 1. In the image capturing step, at least a part of a subject P's body such as a hand 7 or a leg 8 is captured as peripheral image by having the wide-angle camera 1 mounted on the subject P's body.

At this stage, when machine learning is performed in advance using multiple training data sets, a training step may be included in which machine learning is performed using a virtual subject configured from data or information of the subject P. This makes it possible to start the measurement of motion of the subject P even earlier.

Step S12 is a feature point extraction step in which feature points 5a-9a of the acquired image data are extracted.

In the feature point extraction step (step S12), feature points 5a-9a are extracted from a 2D image using the training data that was learnt in the training step.

In this way, the position accuracy of feature points 5a-9a is improved further.

Step S13 is a pose estimation step in which a 3D pose is estimated from a 2D image supplemented with feature points 5a-9a as shown in FIG. 2. In the pose estimation step, the subject P's 3D pose data P1 is estimated from the feature points 5a-9a.

In the pose estimation step, the subject P's 3D pose may be estimated using the training data that is learnt in the training step.

The 3D pose data P1 acquired in this way is stored in the storage 14 so that it may be used as data for another subject.

Also, in the same way as with conventional motion capture techniques, the pose data P1 can be used for various applications in areas such as sports, academic research, and animation production.

In particular, because the motion measurement system of the embodiment is capable of taking measurements by mounting a wide-angle camera 1 on the chest of a subject P, there is little possibility of the subject P's movement being obstructed. Therefore, the motion measurement system is ideal for allowing a subject P to have freedom of action to acquire desired data.

As mentioned above, the motion measurement system of the embodiment uses a wide-angle camera 1 that is mounted on the body of a subject P to capture body parts such as a chin 5, an elbow 6, a hand 7, a leg 8, and a shoulder 9 as a peripheral image. In this way, the pose of a subject P may be measured with ease and a 3D pose be estimated.

Furthermore, compared to the putting on and off of a full body suit or other equipment that was required with conventional techniques, the wide-angle camera 1 may be worn with ease with a belt 4 (see FIG. 1), thereby reducing the subject P's burden with regards to the putting on and putting off of equipment. Yet further, compared to the conventional full body suit, the motion measurement system may be configured more cheaply.

Yet further, the motion measurement system demonstrates practically beneficial effects including the ability to capture the movement of a subject P without restricting the space in which the subject moves, thus allowing movement to be captured, for example, in outdoor space.

Peripheral parts of a round image that is acquired from the wide-angle camera 1 where a subject P's chin 5, elbow 6, hand 7, leg 8, and shoulder 9 are captured are heavily distorted due to the characteristics of a fisheye lens 3. Shapes that are captured are deformed, making them difficult to be discerned. A distorted peripheral image changes its shape significantly with different conditions, making the determination of feature points difficult, not only for untrained eyes, but for experts such as operators as well.

The feature point extractor 12 of the embodiment extracts feature points 5a-9a from a 2D image during the feature point extraction step (step S12) using training data that is learnt in the training step.

With deep learning that uses training data, it is possible to decide with ease where the subject P's chin 5, each elbow 6, each hand 7, each leg 8, and each shoulder 9 are from an image that does not contain a shape of a person. For this reason, the accuracy of extraction may be increased to the same level as a trained operator or even higher.

Therefore, the precision of the measurement system 10 of the first embodiment may be made better than other image processing techniques that use a conventional method of inferring locations of a chin 5 and other body parts from contrasts and angles.

Furthermore, the neural network of the 3D pose estimator 13 generates 3D pose data P1 based on training data accumulated by machine learning. As a result, 3D pose data P1 that may be used for various purposes is acquired.

In this way, with the measurement system 10 of the first embodiment, a full body suit and various sensors that are laborious to put on and off become unnecessary, and the space in which an image may be captured increases, including outdoor space. In addition, it is possible to add the measured data to the training data, making it possible to increase measurement accuracy even further.

### Second Embodiment

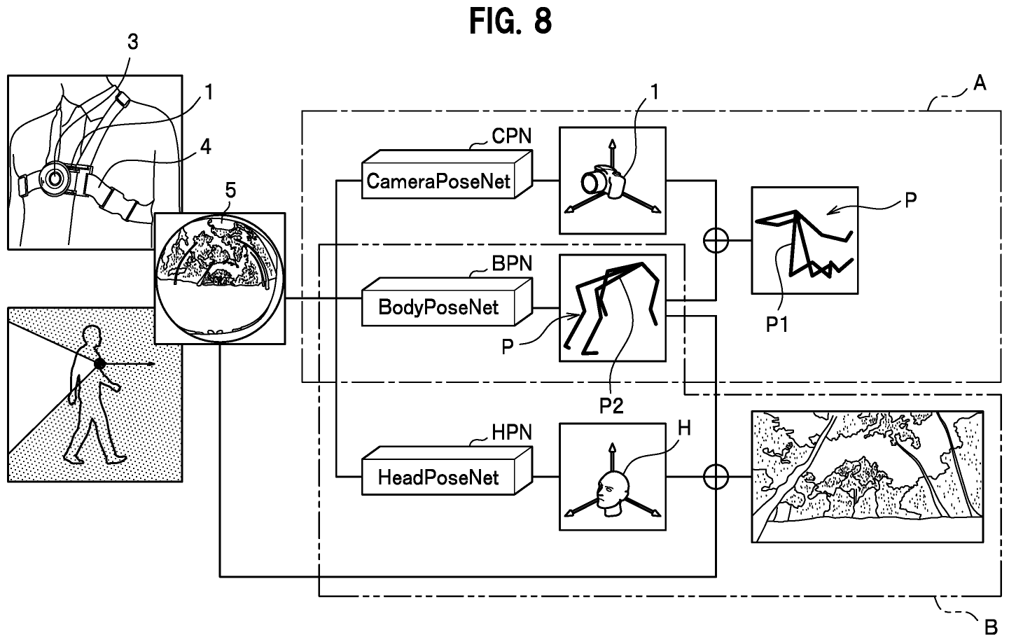

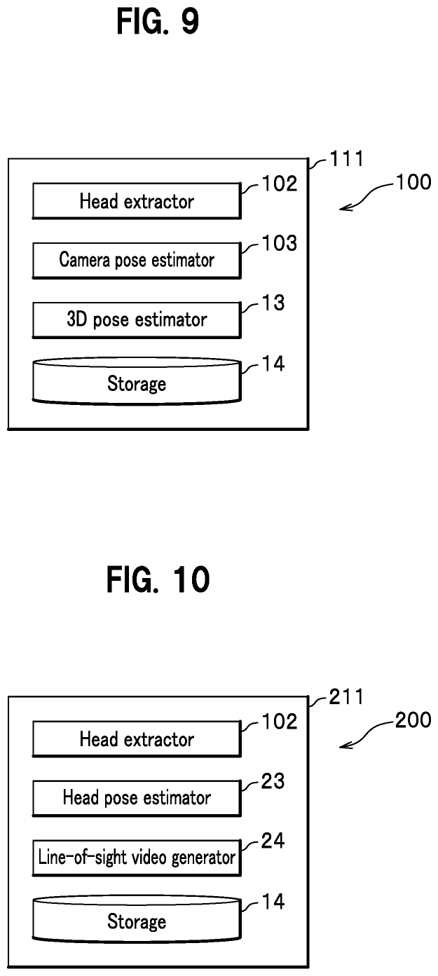

FIGS. 8 and 9 show a motion measurement system 100 according to a second embodiment. In the description of the second embodiment, elements that are in common with the first embodiment are denoted by the same reference symbols and repeat descriptions are avoided.

In addition to the BPN (see FIG. 8) of the first embodiment, the motion measurement system 100 of the second embodiment shown in FIG. 9 further includes the following in the system body 111: a head extractor 102, a camera pose estimator 103, a 3D pose estimator 13, and a storage 14.

As shown in FIG. 8, the camera pose estimator 103 includes a CameraPoseNet (a CPN) configured from fully connected layers. Here, multiple sets of artificial training data that have been prepared artificially in advance are available for the training of the CPN.

The artificial training data is prepared from persons in a VR (virtual reality) space that each has different features such as age, gender, a physical feature, and clothes using a virtual subject configured from data or information of a subject. This way, it is possible to carry out training with a large amount of different data compared to training through the use of data of an actual person as a subject, thus making the training more efficient.

The CPN estimates the pose of the wide-angle camera 1 that includes directions in an upward and downward direction and a leftward and rightward direction based on multiple sets of artificial image data for training that have been learned. Note that the estimation of the pose is performed based on training in which multiple sets of artificial image data for training that have been captured in advance with a sample-taking wide-angle camera are learned.

The 3D pose estimator 13 corrects the three-dimensional pose data P1 and P2 (see FIG. 8) of a subject P based on the pose of the wide-angle camera 1 estimated by the camera pose estimator 103.

Operation of the motion measurement system 100 according to the second embodiment is described below. The motion measurement system 100 includes a step in which the pose of the wide-angle camera 1 that includes directions in the upward and downward direction and leftward and rightward direction is estimated from an image of the wide-angle camera 1 and a step in which the pose of a subject P is estimated by performing correction using the estimated pose of the wide-angle camera 1.

The motion measurement system 100 according to the second embodiment configured in this way uses the pose of the camera 1 estimated by the camera pose estimator 103 to estimate, for example, whether the subject P is in a sitting pose P1 or a standing and bending forward pose P2, so that the pose of the subject P is corrected to an actual pose (see section shown by reference symbol A in FIG. 8).

In the example shown in FIG. 8, the wide-angle camera 1 is mounted on the chest of a subject P who is in a sitting position. The CPN of the camera pose estimator 103 estimates that the pose of the camera 1 is forward facing and oriented horizontally. The 3D pose estimator 13 derives a subject P in a sitting pose P1 in the same way as the first embodiment and with correction that takes into account the pose of the camera 1.

Through correction of the pose of the subject P using the estimated pose of the wide-angle camera 1, it becomes clear that the subject P is not in a standing and bending forward pose P2, but in a sitting pose P1. In other words, by using the CPN of the camera pose estimator 103, the correct pose of a subject P may be estimated when the pose is ambiguous.

### Third Embodiment

FIGS. 10-14 are drawings concerning a motion measurement system 200 according to a third embodiment. In the description of the third embodiment, elements that are in common with the first and second embodiments are denoted by the same reference symbols and repeat descriptions are avoided.

Conventional methods for measuring a human line of sight include methods that use a camera fixed to a display and methods where a subject P wears a pair of glasses mounted with a line-of-sight measurement camera.

However, the use of a fixed camera leads to restrictions on the actions of the subject P, and the line-of-sight measurement camera needs to be installed in close proximity to an eye of the subject P.

In comparison, the motion measurement system 200 according to the third embodiment involve the mounting of a single wide-angle camera 1 on the chest of the subject P (see top left side of FIG. 8). The wide-angle camera 1 is installed with either a fisheye lens or an ultra-wide-angle lens (preferably with a 280-degree view). A wide-angle camera 1 that is capable of capturing the subject P's surroundings and at least a part of the subject P's head such as a chin 5 or a lower part of a face or head may be used.

As shown in FIG. 10, the motion measurement system 200 according to the third embodiment includes a head extractor 102, a head pose estimator 23, a line-of-sight video generator 24, and a storage 14.

The head extractor 102 performs the extraction of the pose and position of the head H of a subject (see section B of FIG. 8) using an image of the chin 5.

The head pose estimator 23 includes a HeadPoseNet (HPN; see FIG. 8) configured from fully connected layers. The HPN estimates the pose of the subject P's head H based on multiple sets of artificial image data for training that have been learned.

Based on the pose of the head H that is estimated by the head pose estimator 23, the line-of-sight image generator 24 generates a flat image of a view that is seen in the line of sight of the subject P.

The 3D pose of the subject P's head is estimated. The head pose estimator 23 estimates the pose of the head H by using the head H extracted by the head extractor 102 from an image captured by the wide-angle camera 1. The pose estimation of the head H by the head pose estimator 23 is performed in the same way as the pose estimation of the subject P by the 3D pose estimator 13 of the first embodiment.

The line-of-sight image generator 24 of the motion measurement system 200 functions in the following way.

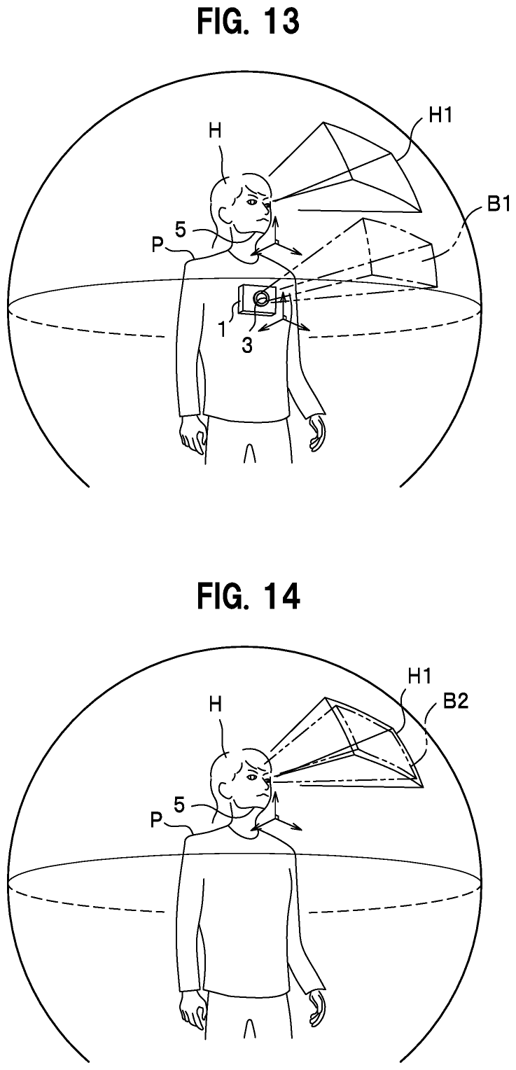

As shown in FIG. 13, an image B1 captured by the wide-angle camera 1 and an image H1 in an actual line of sight are different mainly in their positions in the direction of height. Thus, the line-of-sight image generator 24 generates an image B2 so that, as shown in FIG. 14, an image captured by the wide-angle camera 1 matches the image H1 in the actual line of sight.

During this stage, the line-of-sight image generator 24 estimates a direction of a line of sight of the subject P from mainly the pose of the chin 5 of the head H that is estimated by the head pose estimator 23. The line-of-sight image generator 24 generates the image B2 in the direction of the line of sight from the image captured by the wide-angle camera 1.

The motion measurement system 200 according to the third embodiment includes a deep learning device configured from an HPN (HeadPoseNet) within the head pose estimator 23 in the same way as the decoder 40 of the first embodiment. Pose estimation of the head H of the subject P is performed using HPN training data that has been acquired in advance through machine learning. With deep learning by the deep learning device, the accuracy of the direction of a line of sight of the subject P may be improved by increasing the image data for HPN training used for training.

Therefore, in addition to the BPN of the first embodiment, the motion measurement system 200 of the third embodiment further includes the following in the system body 211 as shown in FIG. 10: a head extractor 102, a head pose estimator 23 (including HPN; see section B of FIG. 8), a line-of-sight image generator 24, and a storage 14.

The head pose estimator 23 includes a HeadPoseNet (HPN; see FIG. 8) configured from fully connected layers. The HPN estimates the pose of the head H of a subject P based on multiple sets of artificial image data for training that have been learned. Based on the pose of the head H that is estimated by the head pose estimator 23, the line-of-sight image generator 24 generates a flat image of a view in a line of sight of the subject P.

Next, the effects of the motion measurement system 200 of the third embodiment is described.

The motion measurement system 200 of the second embodiment that is configured in this way includes the following steps: (a) a head pose estimation step of estimating the pose of the head H of a subject P; (b) a line-of-sight direction estimation step of estimating the direction of a line of sight of the subject P from the estimated pose of the head H; and (c) a line-of-sight image generation step of generating an image in the direction of a line of sight from an image captured by the wide-angle camera 1.

Due to this, in addition to the effects of the motion measurement system of the first embodiment, the motion measurement system 200 may display an enlarged planar image of an image that exists in the line of sight of the subject P from a wide-angle image captured by either a fisheye lens or an ultra-wide-angle lens (preferably with an approximately 280-degree view).

Therefore, a pose estimation device 200 that is able to follow the line of sight of a subject P is achieved with the use of a single wide-angle camera 1, thereby making it possible to reduce the manufacturing cost.

Furthermore, the wide-angle camera 1 may be worn on the chest of a subject P with the use of a belt 4 in the same way as the first embodiment. For this reason, a line-of-sight estimation and head pose estimation may be achieved safely and without putting a constraint on the actions of the subject P as with conventional methods.

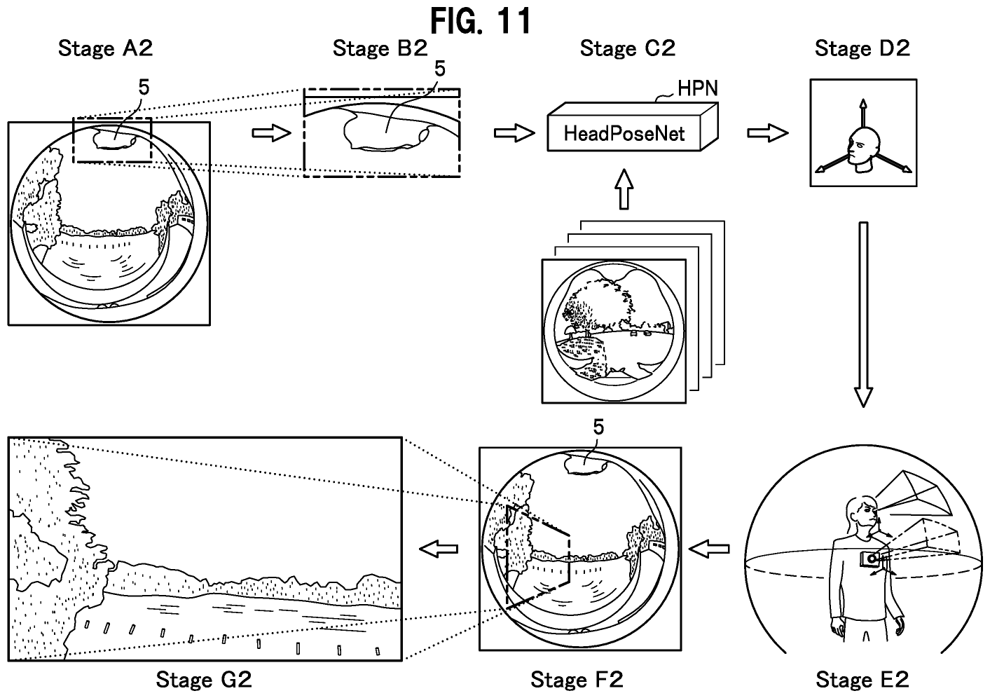

In other words, as shown in the drawing of Stage A2 of FIG. 11, when the wide-angle camera 1 captures a fisheye image, a chin 5 that is a part of the head of the subject P is included in the peripheral part of the image. The head extractor 102 (see FIG. 10) of the system body 11 of the motion measurement system 200 cuts out the chin 5 part of the image as separate image data as shown in the drawing of Stage B2 of FIG. 11.

In the drawing of Stage C2 of FIG. 11, the HPN shown in FIG. 8 estimates the pose of the head H of the subject P from the cut-out image data based on multiple sets of artificial image data for training that has been learned.

When the line of sight that is estimated with this method was compared with a line of sight that was actually acquired with a head mounted camera, with the artificial image data for training that was read in by the embodiment, the following errors were found: errors of 4.4 degrees in the yaw axis, 4.5 degrees in the roll direction, 3.3 degrees in the pitch axis, and an average error of 4.1 degrees. Approximately 680,000 images worth of artificial image data were used as training data for the above comparison. On the other hand, with real image data, errors of 16.9 degrees in the yaw axis, 11.3 degrees in the roll direction, 11.3. degrees in the pitch axis, and an average error of 13.2 degrees were found.

In the case of real image data, accuracy may be improved further by increasing the number of training data sets that are fed to the HPN. For example, real image data corresponding to approximately 16,000 images may be used.

The line-of-sight image generator 24 cuts out a quadrangular area that is estimated to be in the projected line of sight from a fisheye image. The line-of-sight image generator 24 converts the cut out from the fisheye image into a planar rectangle (say, 16:4 or 4:3) and generates a two-dimensional line-of-sight image.

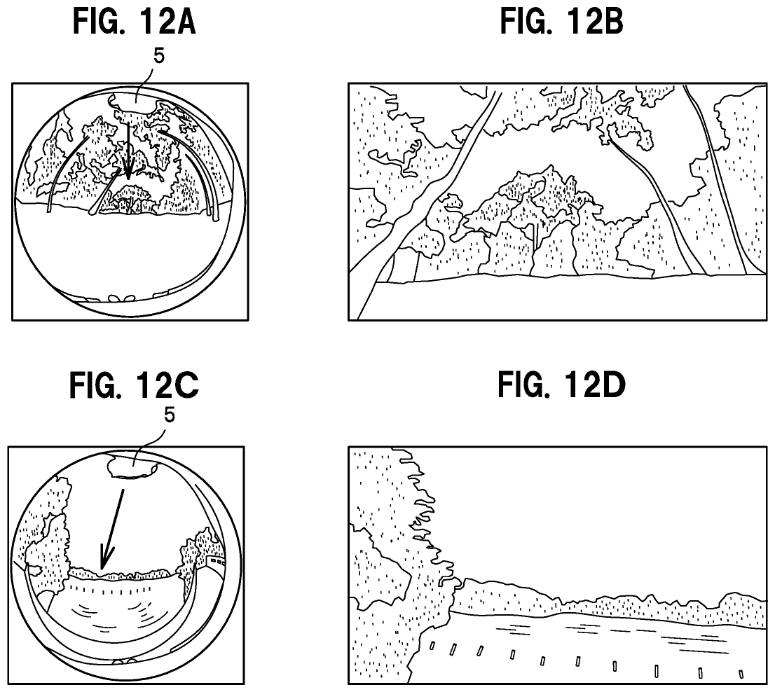

When the head faces forward as shown by the arrow drawn in FIG. 12A, a two-dimensional line-of-sight image centered on the forward direction of the subject P is acquired as shown by FIG. 12B.

When the head faces diagonally to the left as shown by the arrow drawn in FIG. 12C, even if the body of the subject P faces the forward direction, a two-dimensional line-of-sight image that is centered on the diagonally left direction in the line of sight is acquired.

As shown in FIGS. 12B and 12D, distortion and bending in the periphery may be reduced or removed from the line-of-sight image.

In this way, a line-of-sight image may be acquired with the wide-angle camera 1 that may be mounted onto the chest of a subject P with ease and puts little constraint on the actions of the subject P. For this reason, the motion measurement system 200 according to the third embodiment provides good convenience of use.

Furthermore, as shown in FIG. 13, even when a position of an image B1 captured by the wide-angle camera 1 and a position of an image H1 in the actual line of sight are different in a height direction, with the third embodiment, an image B2 at the same height as the image H1 may be acquired as an image in the line of sight. In this way, the accuracy of an image that is captured by a line of sight may further be improved.

A motion measurement system and a pose estimation program according to the first, second, and third embodiments have been described in detail in the foregoing description. However, the present disclosure is not limited to the embodiments herein, and may be modified as appropriate within a scope that does not depart from the spirit of the present disclosure.

For example, the wide-angle camera 1 can be positioned anywhere as long it is placed where at least a part of a subject's body can be captured, including on protective equipment such as a helmet or mask worn during a sports activity, on the top of a head, or on the side of a head.

Furthermore, the wide-angle camera 1 can be arranged at a specific distance away from a subject's body by using an apparatus such as an arm extending from a mount that is worn on the body. Yet further, instead of mounting one wide-angle camera 1 on the chest, a pair of wide-angle cameras 1 can be arranged on the front and back of the body, or on the right- and left-hand side of the body. Multiple wide-angle cameras 1 may be used instead of just one.

Furthermore, according to the embodiments, the feature point extractor 12 determines where a subject P's chin 5, each elbow 6, each hand 7, each leg 8, and each shoulder 9 are individually through deep learning that use training data. However, the disclosure is not limited to this so long as feature points can be extracted. A physical constraint may be used to extract a feature point, or a physical constraint may be used in conjunction with deep learning.

Furthermore, the extraction of feature points by the feature point extractor 12 may be performed by using an image taken with multiple markers attached to a subject P's body. In this case, extraction of feature points through deep learning may be omitted. Note also that the number of feature points may be any number and is not restricted to those of the embodiments (described using feature points 5a-9a). For example, the number of feature points may be somewhere between twelve and twenty-four.

Furthermore, when a 3D pose estimator 13 of the embodiments performs an estimation of a 3D pose using training data that is acquired in advance through machine learning, the 3D pose estimator 13 configures a skeletal structure within data by linking feature points.

However, the disclosure is not limited to this, and a skeletal structure within data may be configured, for example, by only using a same combination of constraints as a human skeletal structure. Alternatively, a skeletal structure within data may be configured by using a same combination of constraints as a human skeletal structure and by linking feature points.

Furthermore, instead of using estimated data as is, a movement model of a human body and inverse kinematics may be used so that estimation is limited to postures that are possible in human movement.

What is claimed is:

1. A motion measurement system comprising:
a wide-angle camera configured to capture an image including at least a part of a body of a subject when worn on the body of the subject;
a feature point extractor configured to extract a feature point from the image; and
a 3D pose estimator configured to estimate a 3D pose of the subject by using the feature point.

2. A motion measurement system according to claim 1, wherein
the feature point extractor is configured to extract the feature point by using training data acquired in advance through machine learning.

3. A motion measurement system according to claim 1, wherein
the 3D pose estimator is configured to estimate the 3D pose by using training data acquired in advance through machine learning.

4. A motion measurement system according to claim 2, wherein
the 3D pose estimator is configured to estimate the 3D pose by using training data acquired in advance through machine learning.

5. A motion measurement system according to claim 1, wherein
the 3D pose estimator is configured to configure a skeletal structure within data by connecting feature points.

6. A motion measurement system according to claim 2, wherein
the 3D pose estimator is configured to configure a skeletal structure within data by connecting feature points.

7. A motion measurement system according to claim 3, wherein
the 3D pose estimator is configured to configure a skeletal structure within data by connecting feature points.

8. A motion measurement system according to claim 4, wherein
the 3D pose estimator is configured to configure a skeletal structure within data by connecting feature points.

9. A motion measurement system according to claim 2, wherein
the machine learning includes an inference based on probability using multiple sets of the training data.

10. A motion measurement system according to claim 3, wherein
the machine learning includes an inference based on probability using multiple sets of the training data.

11. A motion measurement system according to claim 4, wherein
the machine learning includes an inference based on probability using multiple sets of the training data.

12. A motion measurement system according to claim 1, wherein
a lens of the wide-angle camera includes a fisheye lens.

13. A motion measurement system according to claim 1, further comprising:
a camera pose estimator configured to estimate a pose of the wide-angle camera in at least an upward and downward direction, wherein
the 3D pose of the subject is estimated upon correction based on the pose of the wide-angle camera that is estimated by the camera pose estimator.

14. A motion measurement system comprising:
a wide-angle camera configured to capture an image including at least a part of a body of a subject when worn on the body of the subject;
a feature point extractor configured to extract a feature point a camera pose estimator configured to estimate a pose of the wide-angle camera in at least an upward and downward direction from the image; and
a 3D pose estimator configured to estimate a 3D pose of the subject.

15. A motion measurement system according to claim 1, further comprising:
a head pose estimator configured to estimate a pose of a head of the subject; and
a line-of-sight video generator configured to estimate a direction of a line of sight of the subject from the estimated pose of the head and to generate a video in the direction of the line of sight from the image captured by the wide-angle camera.

16. A motion measurement system comprising:
a wide-angle camera configured to capture an image including at least a head of a body of a subject when worn on the body of the subject;
a head pose estimator configured to estimate a pose of the head of the subject by using training data acquired in advance through machine learning; and
a line-of-sight video generator configured to estimate a direction of a face of the subject from the estimated pose of the head and to generate a video in a direction of a line of sight from the image captured by the wide-angle camera.

17. A program comprising:
an image taking step configured to take an image including at least a part of a body of a subject with a wide-angle camera worn on the body of the subject;
a feature point extraction step configured to extract a feature point from the image; and
a pose estimation step configured to estimate a 3D pose of the subject from the feature point.

18. The program according to claim 17, further comprising:
a training step configured to perform machine learning by using a virtual subject configured from data or information of a subject when the machine learning is performed in advance with multiple sets of training data.

19. The program according to claim 18, wherein
the feature point extraction step is configured to extract the feature point from the image by using the training data learnt in the training step.

20. The program according to claim 18, wherein
the pose estimation step is configured to estimate the 3D pose of the subject by using the training data learnt in the training step.

21. The program according to claim 19, wherein
the pose estimation step is configured to estimate the 3D pose of the subject by using the training data learnt in the training step.

22. The program according to claim 17, further comprising:
a step configured to estimate a pose of the wide-angle camera in at least an upward and downward direction from the image of the wide-angle camera; and
a step configured to estimate a pose of the subject upon correction by using the estimated pose of the wide-angle camera.

23. A program comprising:
an image taking step configured to take an image including at least a part of a body of a subject with a wide-angle camera worn on the body of the subject;
a step configured to estimate a pose of the wide-angle camera in at least an upward and downward direction from the image of the wide-angle camera; and
configured to estimate a pose of the subject upon correction by using the estimated pose of the wide-angle camera.

24. A program comprising:
an image taking step configured to take an image including at least a part of a head of a body of a subject with a wide-angle camera worn on the body of the subject;
a head pose estimation step configured to estimate a pose of the head of the subject from the taken image;
a line-of-sight direction estimation step configured to estimate a direction of a line of sight of the subject from the estimated pose of the head; and
a line-of-sight video generation step configured to generate a video in the direction of the line of sight from the image captured by the wide-angle camera.
